(19) United States
(12) Patent Application Publication
(10) Pub. No.: US 2016/0260181 A1
(43) Pub. Date: Sep. 8, 2016

(54) Forecasting Production Data for Existing Wells and New Wells

(71) Applicant: LANDMARK GRAPHICS CORPORATION, Houston, TX (US)

(72) Inventor: Ajay Pratap Singh, Houston, TX (US)

(21) Appl. No.: 14/646,688

(22) PCT Filed: Apr. 30, 2014
(86) PCT No.: PCT/US14/36224

§ 371 Date: May 21, 2015

(51) Int. Cl. G06Q 50/02; G06Q 10/04; G06Q 10/06

(52) U.S. Cl. CPC G06Q 50/02; G06Q 10/0639; G06Q 10/04; G06Q 10/067

(57) ABSTRACT

Systems and methods for forecasting production data for existing wells and new wells using normalized production data for the existing wells, clustering of the existing wells, a production data matrix for each cluster of existing wells, a fitted decline curve for each cluster of existing wells based on a respective production data matrix, and a standard decline curve.

### CROSS-REFERENCE TO RELATED APPLICATIONS

Not applicable.

### STATEMENT REGARDING FEDERALLY SPONSORED RESEARCH

Not applicable.

### FIELD OF THE DISCLOSURE

The present disclosure generally relates to systems and methods for forecasting production data for existing wells and new wells. More particularly, the present disclosure relates to forecasting production data for existing wells and new wells using normalized production data for the existing wells, clustering of the existing wells, a production data matrix for each cluster of existing wells, a fitted decline curve for each cluster of existing wells based on a respective production data matrix, and a standard decline curve.

### BACKGROUND

An important part of prospecting, drilling and developing oil fields is the use of numerical or analytical reservoir models. Analytical models are simple to design while numerical models are more complex and require more effort and data to design. Both types of models require tuning model parameters to match known production rates (e.g. production data for oil, water, gas, etc.), which may then be used in a standard decline curve analysis to understand reservoir performance and forecast production data. There are many different well known techniques for performing a standard decline curve analysis, which are primarily driven by curve fitting to actual production data of each well. While such an approach may work in some cases, it is not considered very reliable because the curve fitting is often poor due to a lack of production data, the quality of the available production data and/or the use of a wrong model.

### BRIEF DESCRIPTION OF THE DRAWINGS

The present disclosure is described below with references to the accompanying drawings in which like elements are referenced with like reference numerals, and in which:

FIG. 1A is a flow diagram illustrating one embodiment of a method for implementing the present disclosure.

FIG. 1B is a flow diagram illustrating a continuation of the method illustrated in FIG. 1A.

FIG. 1C is a flow diagram illustrating a continuation of the method illustrated in FIG. 1B.

FIG. 2 is a graph illustrating actual production data for 34 wells of interest.

FIG. 3 is a production data matrix illustrated in the form of P=USV^{T} with exemplary components for each sub-matrix.

FIG. 4 is a block diagram illustrating the exemplary components for each sub-matrix in FIG. 3 rearranged in a corresponding format (top row) and rewritten (bottom row).

FIG. 5 is a graph illustrating a distribution of Eigen values for each of the 34 wells of interest in FIG. 2.

FIG. 6 is a graph illustrating the fit between the normalized production data (observed) for one of the 34 wells of interest in FIG. 5 and the approximated production data based on the first two components identified in the production data matrix in FIG. 3.

FIG. 7 is a graph illustrating the distribution of the same 34 wells of interest in FIG. 5 according to a minimum number of components and corresponding weights.

FIG. 8 is the same graph in FIG. 7 illustrating the same 34 wells of interest clustered into five separate groups.

FIG. 9 is a block diagram illustrating one embodiment of a computer system for implementing the present disclosure.

### DETAILED DESCRIPTION OF THE PREFERRED EMBODIMENTS

The present disclosure overcomes one or more deficiencies in the prior art by providing systems and methods for forecasting production data for existing wells and new wells using normalized production data for the existing wells, clustering of the existing wells, a production data matrix for each cluster of existing wells, a fitted decline curve for each cluster of existing wells based on a respective production data matrix, and a standard decline curve.

In one embodiment, the present disclosure includes a method for a method for forecasting production data based on normalized production data for one or more wells of interest, which comprises: a) identifying components and corresponding weights in a production data matrix using singular value decomposition, the normalized production data and a computer processor; b) identifying a minimum number of the components and the corresponding weights in the production data matrix needed to reproduce the normalized production data using the computer processor; c) selecting a number for clustering the well(s) of interest based on a distribution of the well(s) of interest according to the minimum number of the components identified in the production data matrix; d) clustering the well(s) of interest based on the number selected for clustering and the well(s) of interest that have a similar production profile; e) identifying components and corresponding weights in a production data matrix for each respective cluster of wells using singular value decomposition, the normalized production data for each respective cluster of wells and the computer processor; f) identifying a minimum number of the components and the corresponding weights in each production data matrix needed to reproduce the normalized production data for each respective cluster of wells using the computer processor; g) calculating a fitted decline curve for the normalized production data for each respective cluster of wells using a first component in the minimum number of components identified for each respective cluster of wells and a standard decline curve; and h) forecasting production data for one of one or more new and existing wells in each respective cluster of wells using the fitted decline curve for each respective cluster of wells.

In another embodiment, the present disclosure includes a non-transitory program carrier device tangibly carrying computer executable instructions for forecasting production data based on normalized production data for one or more wells of interest, which comprises: a) identifying components and corresponding weights in a production data matrix using singular value decomposition and the normalized production data; b) identifying a minimum number of the components and the corresponding weights in the production data matrix needed to reproduce the normalized production data; c) selecting a number for clustering the well(s) of interest based on a distribution of the well(s) of interest according to the minimum number of the components identified in the production data matrix; d) clustering the well(s) of interest based on the number selected for clustering and the well(s) of interest that have a similar production profile; e) identifying components and corresponding weights in a production data matrix for each respective cluster of wells using singular value decomposition and the normalized production data for each respective cluster of wells; f) identifying a minimum number of the components and the corresponding weights in each production data matrix needed to reproduce the normalized production data for each respective cluster of wells; g) calculating a fitted decline curve for the normalized production data for each respective cluster of wells using a first component in the minimum number of components identified for each respective cluster of wells and a standard decline curve; and h) forecasting production data for one of one or more new and existing wells in each respective cluster of wells using the fitted decline curve for each respective cluster of wells.

In yet another embodiment, the present disclosure includes a non-transitory program carrier device tangibly carrying computer executable instructions for forecasting production data based on normalized production data for one or more wells of interest, the instructions being executable to implement: a) identifying components and corresponding weights in a production data matrix using singular value decomposition and the normalized production data; b) identifying a minimum number of the components and the corresponding weights in the production data matrix needed to reproduce the normalized production data; c) selecting a number for clustering the well(s) of interest based on a distribution of the well(s) of interest according to the minimum number of the components identified in the production data matrix; d) clustering the well(s) of interest based on the number selected for clustering and the well(s) of interest that have a similar production profile; e) identifying components and corresponding weights in a production data matrix for each respective cluster of wells using singular value decomposition and the normalized production data for each respective cluster of wells; f) identifying a minimum number of the components and the corresponding weights in each production data matrix needed to reproduce the normalized production data for each respective cluster of wells; g) repeating steps c)-f) for an increased number for clustering the one or more wells of interest; h) calculating a fitted decline curve for the normalized production data for each respective cluster of wells using a first component in the minimum number of components identified for each respective cluster of wells; and i) forecasting production data for one of one or more new and existing wells in each respective cluster of wells using the fitted decline curve for each respective cluster of wells.

The subject matter of the present disclosure is described with specificity, however, the description itself is not intended to limit the scope of the disclosure. The subject matter thus, might also be embodied in other ways, to include different steps or combinations of steps similar to the ones described herein, in conjunction with other present or future technologies. Moreover, although the term “step” may be used herein to describe different elements of methods employed, the term should not be interpreted as implying any particular order among or between various steps herein disclosed unless otherwise expressly limited by the description to a particular order. While the present disclosure may be applied in the oil and gas industry, it is not limited thereto and may also be applied in other industries to achieve similar results.

### Method Description

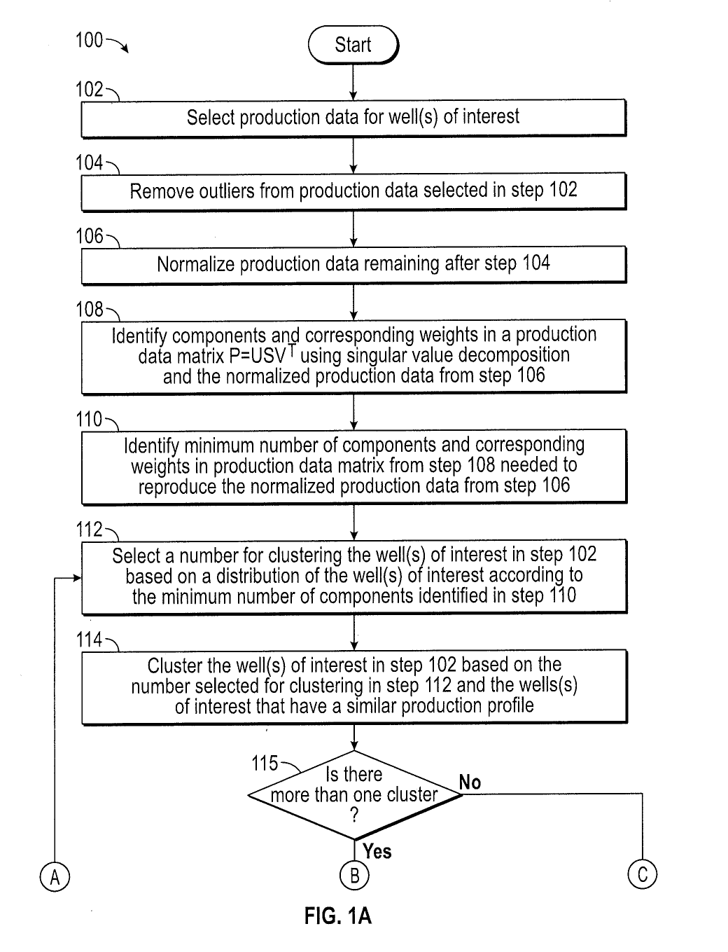

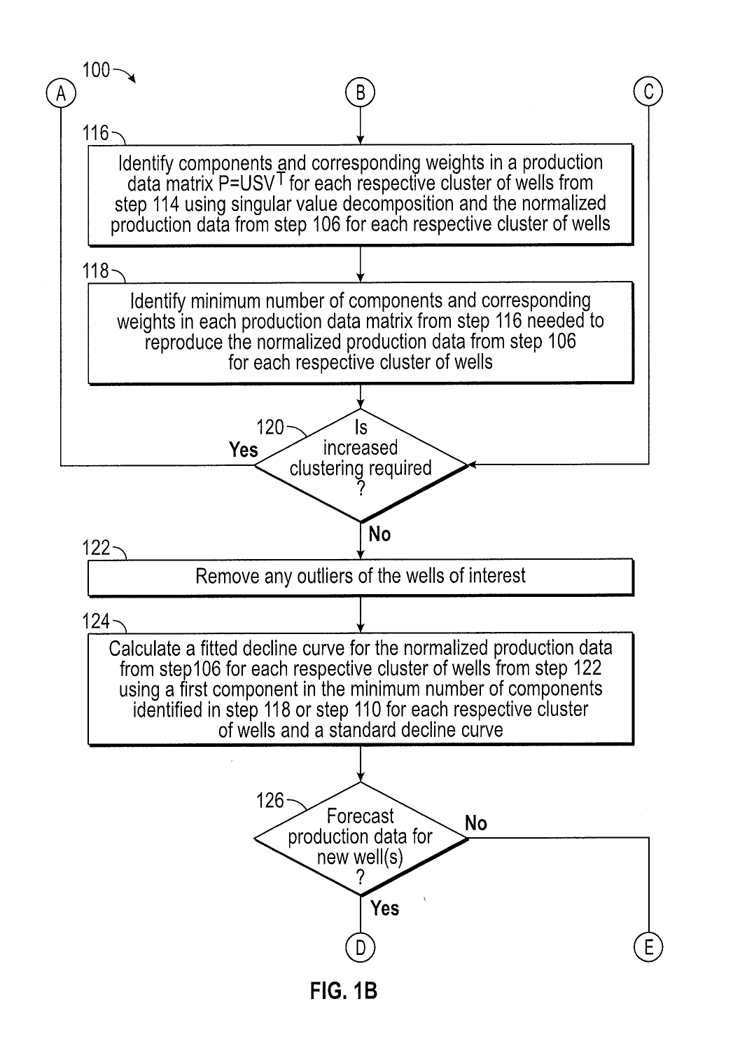

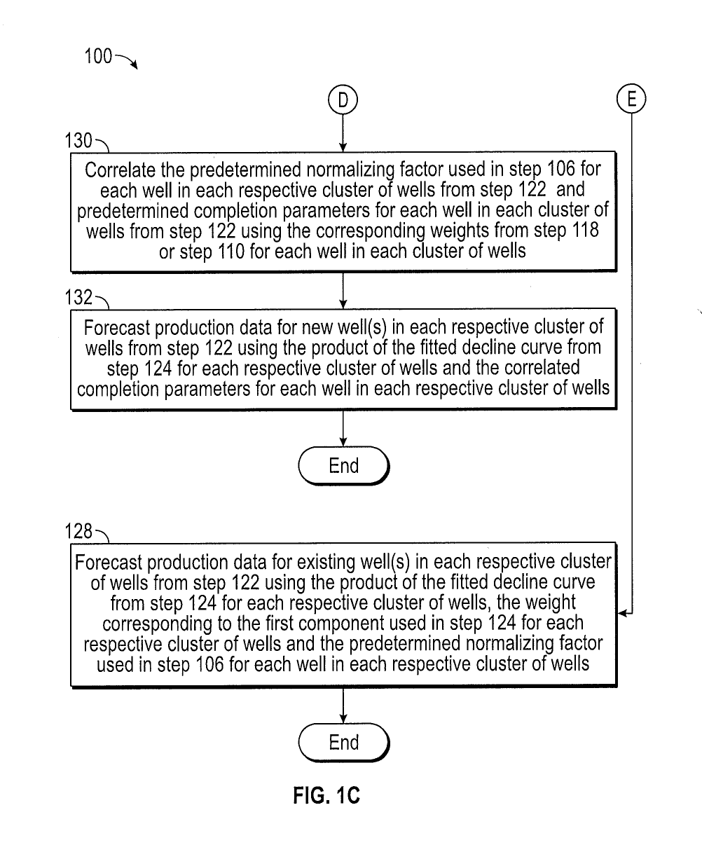

Referring now to FIGS. 1A-1C, the flow diagrams illustrate one embodiment of a method 100 for implementing the present disclosure. The method 100 incorporates statistical techniques that can be used to interpret meaningful information from the production data belonging to group of producing wells. The method 100 can identify i) patterns in production data; ii) wells based on production data and rank them; and iii) wells with similar production profiles. The method 100 can also i) relate well production data to well design and completion design parameters and reservoir parameters; ii) improve the forecast of well production data; and iii) replace standard decline curve analysis.

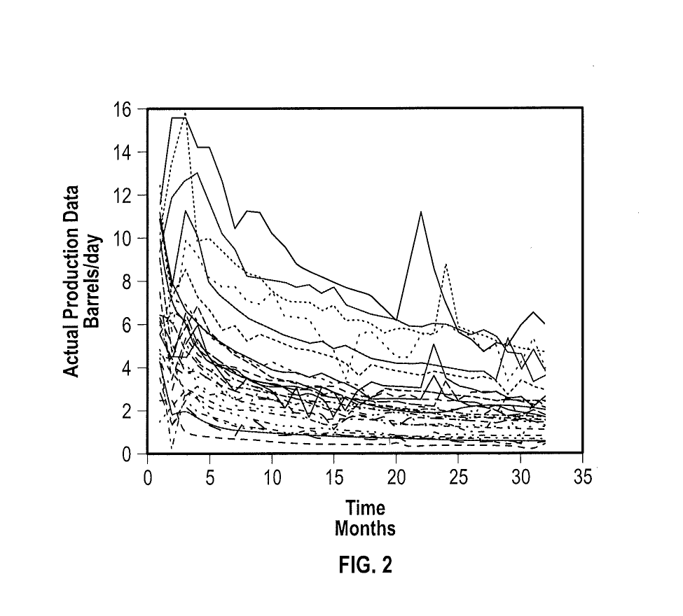

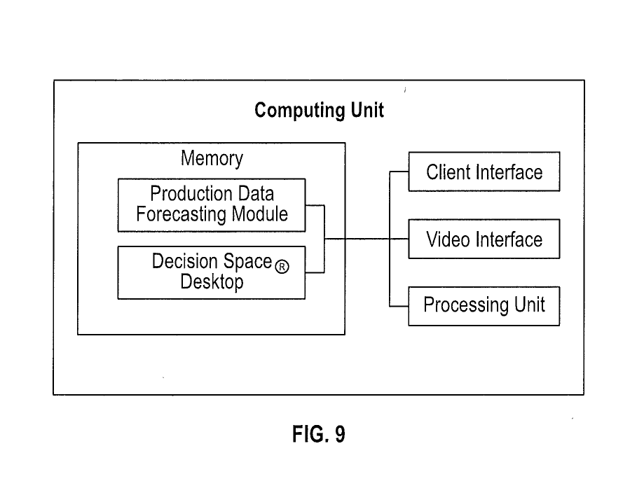

In step 102, production data is automatically selected for the well(s) of interest or it may be manually selected using the client interface and/or the video interface described further, in reference to FIG. 9. In FIG. 2, for example, a graph is used to illustrate actual production data for 34 wells of interest. The production data for each well is represented by a separate line and is plotted on the graph as a function of the production volume in barrels/day per month.

In step 104, outliers are automatically removed from the production data selected in step 102 or they may be manually removed using the client interface and/or the video interface described further in reference to FIG. 9. Outliers may include, for example, any production data reflecting zero production from wells of interest during times when a well is shut down.

In step 106, the production data remaining after step 104 is normalized using techniques well known in the art. The production data illustrated in FIG. 2, for example, may be normalized using:

$${P}_{i} = \frac{{P}_{a , i}}{{P}_{0 , i}} \qquad ( 1 )$$

where P_{a,i} is the actual production data, P_{0,i} is a predetermined normalizing factor and Pᵢ is the normalized production data for the i^{th} well (e.g. i=1 to 34). The normalizing factor P_{0,i} can be chosen based on a maximum value or variance of the production data P_{a,i} for each well.

In step 108, components and corresponding weights in a production data matrix represented by equation (2) are identified using singular value decomposition and the normalized production data from step 106. The normalized production data Pᵢ for each well from step 106 represents a matrix P in equation (2). Singular value decomposition on matrix P can thus, be represented by:

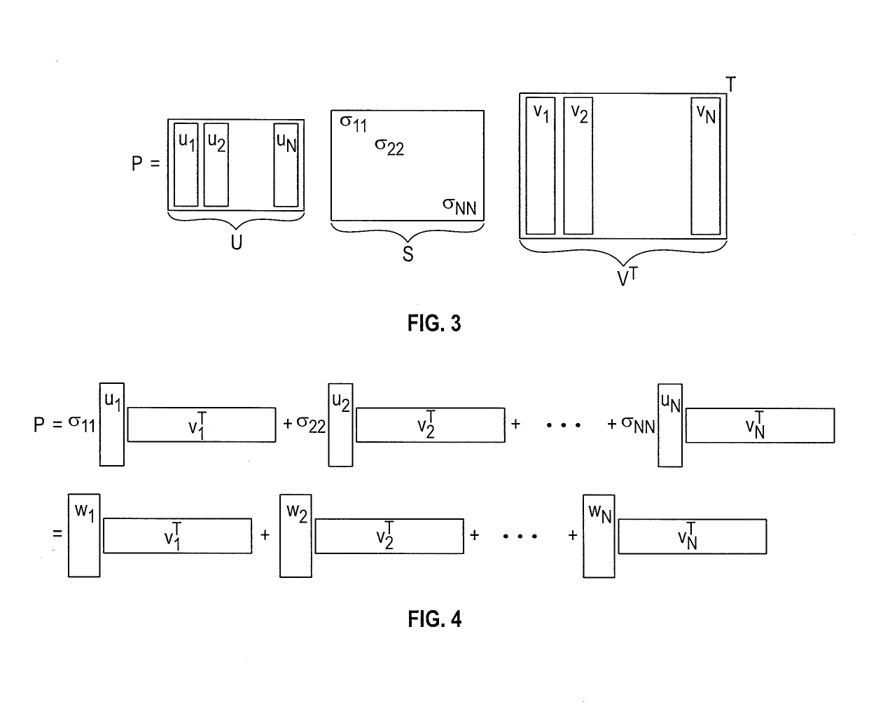

P=USV^{T} (2)

where Pε [symbol] ^{N×M}; N is the number of wells of interest; and M is the number of time steps when production data are reported. Uε [symbol] ^{N×N}, Vε [symbol] ^{M×M} and Sε [symbol] ^{N×M} as illustrated by the matrices in FIG. 3. The superscript T stands for transpose of matrix V in equation (2). S is a diagonal matrix defined as:

$${s}_{ij} = \{ \begin{matrix}0 if i \neq j or j > N \\ σ ij\end{matrix} \} \qquad ( 3 )$$

where σᵢᵢ are also known as Eigen values of matrix P. Each i^{th} column of matrix U and V are represented by uᵢ and vᵢ respectively. As illustrated by the matrices in the top row of FIG. 4, the matrices in FIG. 3 can be rearranged by:

$$P = {\sum }_{i = 1}^{N} {σ}_{ii} {u}_{i} {v}_{i}^{T} for i = 1 , 2 … N \qquad ( 4 )$$

Singular value decomposition results in σᵢᵢ values, which are sorted in decreasing order of their magnitude. Equation (4) suggests that matrix P can be represented by a weighted sum of orthogonal vectors (vᵢ^{T}) and these vectors represent the basic components that capture the decline trends of production data. For each component there is corresponding weight factor vector wᵢ defined by:

wᵢ=σᵢᵢuᵢ (5)

and

$$P = {\sum }_{i = 1}^{N} {w}_{i} {v}_{i}^{T} for i = 1 , 2 … N \qquad ( 6 )$$

As illustrated by the matrices in the bottom row of FIG. 4, the matrices in the top row of FIG. 4 can be rewritten by equation (6) wherein the components (vᵢ^{T}) and corresponding weights (wᵢ) are identified in the production data matrix represented by equation (2) using singular value decomposition and the normalized production data from step 106.

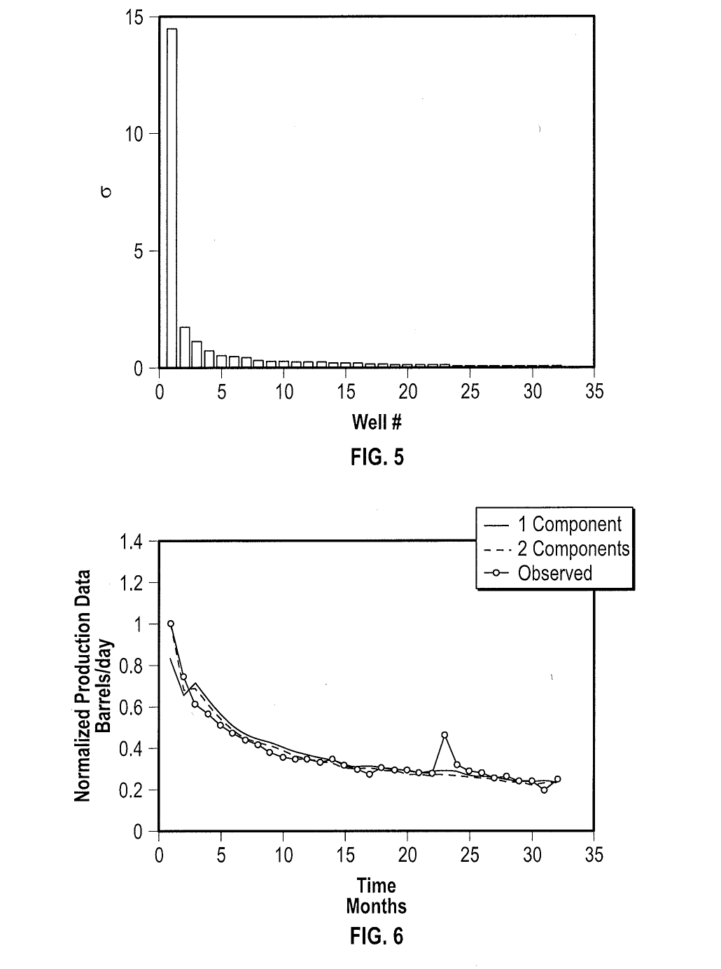

In step 110, a minimum number of components (vᵢ^{T}) and corresponding weights (wᵢ) are automatically identified in the production data matrix from step 108 that are needed to reproduce the normalized production data from step 106 or they may be manually identified using the client interface and/or the video interface described further in reference to FIG. 9. Identification of the minimum number of components (vᵢ^{T}) and corresponding weights (wᵢ) can be accomplished by comparing the distribution of Eigen values (σᵢᵢ) for matrix P for each of the 34 wells of interest as illustrated in FIG. 5. In this manner, equation (4) can be reasonably approximated by:

$$P \approx {\sum }_{i = 1}^{n} {σ}_{ii} {u}_{i} {v}_{i}^{T} = {\sum }_{i = 1}^{n} {w}_{i} {v}_{i}^{T} for i = 1 , 2 … n \qquad ( 7 )$$

where n is the minimum number of components (vᵢ^{T}) and corresponding weights (wᵢ). Alternatively, the minimum number of components (vᵢ^{T}) and corresponding weights (wᵢ) may be identified by how many components are required to reproduce the normalized production data Pᵢ from step 106 with a good fit for all wells. The goodness or quality of fit may be predetermined and/or discretionary such as, for example, a 90% fit to actual production data. In FIG. 6, for example, a graph is used to illustrate the fit between the normalized production data (observed) for one of the 34 wells of interest illustrated in FIG. 5 and the approximated production data based on the first two components identified in the production data matrix from step 108. It is clear that even the first component is good enough to capture an acceptable fit. As the second component is added, the fit is improved.

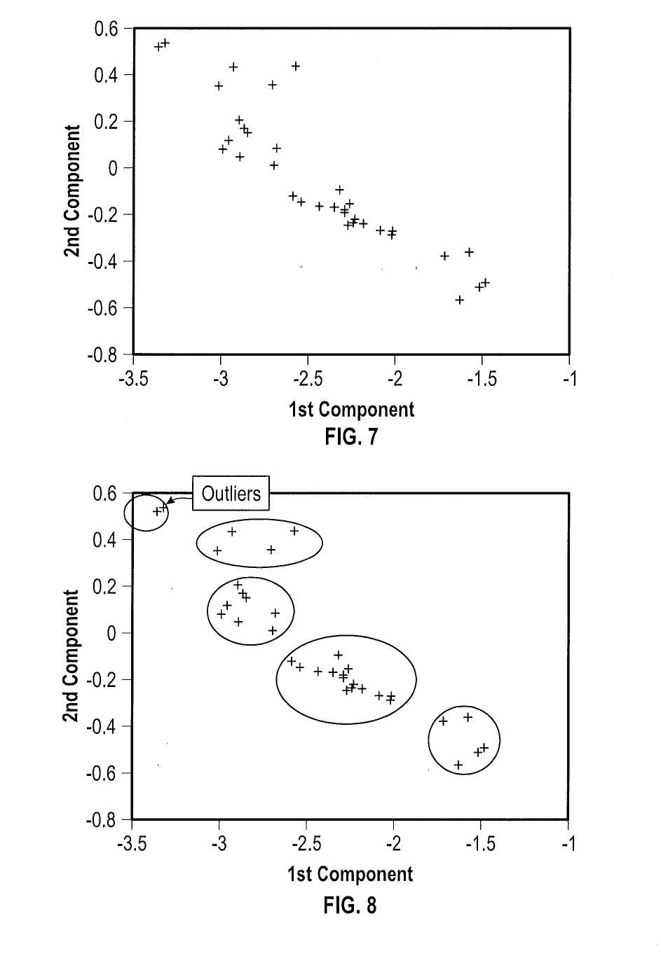

In step 112, a number for clustering (grouping) the well(s) of interest from step 102 is automatically selected based on a distribution of the well(s) of interest according to the minimum number of components identified in step 110 or the number may be manually selected using the client interface and/or the video interface described further in reference to FIG. 9. In this manner, the well(s) of interest that have a similar production profile may be grouped together. A number for clustering may be selected by the distribution of wells on a two-dimensional or a three-dimensional graph using the weights corresponding to the minimum number of components identified in step 110. In FIG. 7, for example, a two-dimensional graph is used to illustrate the distribution of the same 34 wells of interest illustrated in FIG. 5 according to the minimum number of components and corresponding weights (w_{i,1}, w_{i,2}) identified in step 110 (w_{i,j} means weight to j^{th} component for i^{th} well). Although a single cluster may be selected as the number for clustering when small production data sets are used, the example illustrated in FIG. 7 suggests selecting five clusters based on the distribution of wells because there are five groups of wells that appear to have similar production profiles.

In step 114, the well(s) of interest in step 102 are clustered based on the number selected for clustering in step 112 and the well(s) of interest that have a similar production profile. Clustering may be performed by any well known clustering technique such as, for example, the kernel-k-means technique. In FIG. 8, the same two-dimensional graph illustrated in FIG. 7 is used to illustrate clustering. The same 34 wells of interest illustrated in FIG. 7 are clustered into five separate groups wherein one cluster represents an outlier.

In step 115, the method 100 determines if there is more than one cluster of wells. If there is not more than one cluster of wells, then the method 100 proceeds to step 120. If there is more than one cluster of wells, then the method 100 proceeds to step 116.

In step 116, components and corresponding weights in a production data matrix represented by equation (2) are identified for each respective cluster of wells from step 114 using i) singular value decomposition in the same manner as step 108; and ii) the normalized production data from step 106 for each respective cluster of wells.

In step 118, a minimum number of components (vᵢ^{T}) and corresponding weights (wᵢ) are automatically identified in each production data matrix from step 116, in the same manner as step 110, that are needed to reproduce the normalized production data from step 106 or they may be manually identified using the client interface and/or the video interface described further in reference to FIG. 9.

In step 120, the method 100 determines if increased clustering is required. If increased clustering is required, then the method 100 returns to step 112 where a greater number for clustering is selected according to step 112. If increased clustering is not required, then the method 100 proceeds to step 122. To determine if increased clustering is required, the percent (%) variance captured by the first component may be calculated for each cluster and compared to the same for an additional cluster. If, for example, there is no significant increase in the percent (%) variance captured by the first component for five clusters compared to six clusters, then increased clustering is not required. The percent (%) variance captured by the first component is defined by:

$$percent ( \% ) variance by first component = \frac{{σ}_{11}}{{\sum }_{i = 1}^{N} {σ}_{ii}} \qquad ( 8 )$$

In step 122, any outliers of the well(s) of interest are automatically removed or they may be manually removed using the client interface and/or the video interface described further in reference to FIG. 9. In FIG. 8, for example, there are two wells in a single cluster that are outliers.

In step 124, a fitted decline curve is calculated for the normalized production data from step 106 for each respective cluster of wells from step 122 using a first component in the minimum number of components identified in step 110 or step 118 for each respective cluster of wells and a standard decline curve. Because the first component will capture most of the production data decline for wells, equation (7) in step 110 may be used with only the first component for each cluster of wells to approximate the normalized production data by:

P≈w₁v₁^{T} 9(a)

Pᵢ≈w_{1,i}v₁^{T} 9(b)

Here, w_{1,j} represents weight factor vector wᵢ for the i^{th} well for the first component as explained in step 108 for equation (5) for each cluster of wells. For each cluster of wells, the first component v₁^{T}(t) in the minimum number of components identified in step 110 or step 118 is thus, used as a natural decline curve and a standard decline curve (φ) is used to fit the natural decline curve v₁^{T}(t) by minimizing square mean error to obtain:

v₁^{T}(t)=φt (10)

The standard decline curve may be any class of well known hyperbolic curve or exponential curve.

In step 126, the method 100 determines whether to forecast production data for any new well(s). If forecasting production data for any new well(s) is required, then the method 100 proceeds to step 130. If forecasting production data for any new well(s) is not required, then the method 100 proceeds to step 128 to forecast production data for the existing well(s).

In step 128, production data for the existing well(s) in each respective cluster of wells from step 122 is forecast using the product of the fitted decline curve (φ(t)) from step 124 for each respective cluster of wells, the weight (w_{1,j}) corresponding to the first component used in step 124 for each respective cluster of wells and the predetermined normalizing factor (P_{0,i}) used in step 106 for each well in each respective cluster of wells. The product of these components may be represented as:

P_{a,i}≈P_{0,i}w_{1,i}v₁^{T}(t)=P_{0,i}w_{1,j}φ(t) (11)

wherein each curve for each cluster of wells can be used for forecasting production data by using future values for time (t) in equation (11). This eliminates well by well curve fitting because the fitted decline curve represented by equation (10) is applicable to all wells belonging to a cluster.

In step 130, the predetermined normalizing factor (P_{0,i}) used in step 106 for each well in each respective cluster of wells from step 122 and predetermined completion parameters for each well in each cluster of wells from step 122 are correlated using the corresponding weights (w_{1,i}) from step 110 or step 118 for each well in each cluster of wells. The correlation of these components may be represented as:

P_{0,i}w_{1,i}=ƒ(N_{ƒ},K,skin) (12)

wherein the correlation function (ƒ) could be a linear or nonlinear class of function estimated by standard curve fitting or regression techniques; N_{f} represents the number of fractures; K represents the permeability; and skin represents a production value. These are just examples of predetermined completion parameters and others, instead of or in addition to, may be used.

In step 132, production data for new well(s) in each respective cluster of wells from step 122 is forecast using the product of the fitted decline curve (φ(t)) from step 124 for each respective cluster of wells and the correlated completion parameters from step 130 for each well in each respective cluster of wells. The product of these components may be represented as:

P_{a,i}=P_{0,i}w_{1,i}φ(t)=ƒ(N_{ƒ,i},Kᵢ,skinᵢ)φ(t) (13)

wherein each curve for each cluster of wells can be used for forecasting production data by using future values for time (t) in equation (12). This eliminates well by well curve fitting because the fitted decline curve represented by equation (10) is applicable to all wells belonging to a cluster.

The method 100 creates a link between behavior of well production to well design, completion parameters and reservoir parameters. The method 100 can be applied to wells producing oil, gas or both. The method 100 uses clustering to identify outliers, which can be further examined for their extreme behavior. Thus, the method 100 can be directly applied to a large number of wells without requiring much manual data cleaning while identifying hidden information in the production data. Moreover, the method 100 provides a statistically improved production data curve fit that is applicable to all wells rather than the conventional approach of finding a fitted production data curve based on average production of all wells.

### System Description

The present disclosure may be implemented through a computer-executable program of instructions, such as program modules, generally referred to as software applications or application programs executed by a computer. The software may include, for example, routines, programs, objects, components and data structures that perform particular tasks or implement particular abstract data types. The software forms an interface to allow a computer to react according to a source of input. DecisionSpace® Desktop, which is a commercial software application marketed by Landmark Graphics Corporation, may be used as an interface application to implement the present disclosure. The software may also cooperate with other code segments to initiate a variety of tasks in response to data received in conjunction with the source of the received data. The software may be stored and/or carried on any variety of memory such as CD-ROM, magnetic disk, bubble memory and semiconductor memory (e.g. various types of RAM or ROM). Furthermore, the software and its results may be transmitted over a variety of carrier media such as optical fiber, metallic wire and/or through any of a variety of networks, such as the Internet.

Moreover, those skilled in the art will appreciate that the disclosure may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present disclosure. The disclosure may be practiced in distributed-computing environments where tasks are performed by remote-processing devices that are linked through a communications network. In a distributed-computing environment, program modules may be located in both local and remote computer-storage media including memory storage devices. The present disclosure may therefore, be implemented in connection with various hardware, software or a combination thereof, in a computer system or other processing system.

Referring now to FIG. 9, a block diagram illustrates one embodiment of a system for implementing the present disclosure on a computer. The system includes a computing unit, sometimes referred to as a computing system, which contains memory, application programs, a client interface, a video interface, and a processing unit. The computing unit is only one example of a suitable computing environment and is not intended to suggest any limitation as to the scope of use or functionality of the disclosure.

The memory primarily stores the application programs, which may also be described as program modules containing computer-executable instructions, executed by the computing unit for implementing the present disclosure described herein and illustrated in FIGS. 1-8. The memory therefore, includes a production data forecasting module, which enables steps 102-132 described in reference to FIGS. 1A-1C. The production data forecasting module may integrate functionality from the remaining application programs illustrated in FIG. 9. In particular, DecisionSpace® Desktop may be used as an interface application to provide the production data selected in step 102 and to display the images as a result of steps 102, 110, 112, and 114 in FIG. 1A. Although DecisionSpace® Desktop may be used as interface application, other interface applications may be used, instead, or the production data forecasting module may be used as a stand-alone application.

Although the computing unit is shown as having a generalized memory, the computing unit typically includes a variety of computer readable media. By way of example, and not limitation, computer readable media may comprise computer storage media and communication media. The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to, and/or presently being operated on, the processing unit. By way of example, and not limitation, the computing unit includes an operating system, application programs, other program modules, and program data.

The components shown in the memory may also be included in other removable/nonremovable, volatile/nonvolatile computer storage media or they may be implemented in the computing unit through an application program interface (“API”) or cloud computing, which may reside on a separate computing unit connected through a computer system or network. For example only, a hard disk drive may read from or write to nonremovable, nonvolatile magnetic media, a magnetic disk drive may read from or write to a removable, nonvolatile magnetic disk, and an optical disk drive may read from or write to a removable, nonvolatile optical disk such as a CD ROM or other optical media. Other removable/nonremovable, volatile/nonvolatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above provide storage of computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, or the like. These and other input devices are often connected to the processing unit through the client interface that is coupled to a system bus, but may be connected by other interface and bus structures, such as a parallel port or a universal serial bus (USB).

A monitor or other type of display device may be connected to the system bus via an interface, such as a video interface. A graphical user interface (“GUI”) may also be used with the video interface to receive instructions from the client interface and transmit instructions to the processing unit. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well known.

While the present disclosure has been described in connection with presently preferred embodiments, it will be understood by those skilled in the art that it is not intended to limit the disclosure to those embodiments. It is therefore, contemplated that various alternative embodiments and modifications may be made to the disclosed embodiments without departing from the spirit and scope of the disclosure defined by the appended claims and equivalents thereof.

1. A method for forecasting production data based on normalized production data for one or more wells of interest, which comprises:
a) identifying components and corresponding weights in a production data matrix using singular value decomposition, the normalized production data and a computer processor;
b) identifying a minimum number of the components and the corresponding weights in the production data matrix needed to reproduce the normalized production data using the computer processor;
c) selecting a number for clustering the well(s) of interest based on a distribution of the well(s) of interest according to the minimum number of the components identified in the production data matrix;
d) clustering the well(s) of interest based on the number selected for clustering and the well(s) of interest that have a similar production profile;
e) identifying components and corresponding weights in a production data matrix for each respective cluster of wells using singular value decomposition, the normalized production data for each respective cluster of wells and the computer processor;
f) identifying a minimum number of the components and the corresponding weights in each production data matrix needed to reproduce the normalized production data for each respective cluster of wells using the computer processor;
g) calculating a fitted decline curve for the normalized production data for each respective cluster of wells using a first component in the minimum number of components identified for each respective cluster of wells and a standard decline curve; and
h) forecasting production data for one of one or more new and existing wells in each respective cluster of wells using the fitted decline curve for each respective cluster of wells.

2. The method of claim 1, wherein the number selected for clustering the well(s) of interest is one.

3. The method of claim 1, wherein the production data is forecast for the one or more existing wells using a product of the fitted decline curve for each respective cluster of wells, the weight corresponding to the first component for each respective cluster of wells, and a predetermined normalizing factor for each well in each respective cluster of wells.

4. The method of claim 1, wherein the production data is forecast for the one or more new wells using a product of the fitted decline curve for each respective cluster of wells and correlated completion parameters for each well in each respective cluster of wells.

5. The method of claim 4, wherein the completion parameters for each well in each respective cluster of wells are correlated with a predetermined normalizing factor for each well in each respective cluster of wells using the corresponding weights for each well in each respective cluster of wells.

6. The method of claim 4, wherein the completion parameters for each well in each respective cluster of wells are predetermined and comprise a number of fractures, permeability and a production value.

7. The method of claim 1, further comprising removing outliers from the one or more wells of interest before calculating the fitted decline curve for each respective cluster of wells.

8. The method of claim 1, further comprising repeating steps c)-f) for an increased number for clustering the one or more wells of interest until a predetermined acceptable variance is achieved between each first component in the minimum number of components identified for each respective cluster of wells and each first component in the minimum number of component identified for each respective increased cluster of wells.

9. The method of claim 1, wherein the minimum number of the components and the corresponding weights in each production data matrix are identified by comparing a distribution of Eigen values for a matrix representing the normalized production data for each well in each respective cluster of wells.

10. A program carrier device for carrying computer executable instructions for forecasting production data based on normalized production data for one or more wells of interest, the instructions being executable to implement:
a) identifying components and corresponding weights in a production data matrix using singular value decomposition and the normalized production data;
b) identifying a minimum number of the components and the corresponding weights in the production data matrix needed to reproduce the normalized production data;
c) selecting a number for clustering the well(s) of interest based on a distribution of the well(s) of interest according to the minimum number of the components identified in the production data matrix;
d) clustering the well(s) of interest based on the number selected for clustering and the well(s) of interest that have a similar production profile;
e) identifying components and corresponding weights in a production data matrix for each respective cluster of wells using singular value decomposition and the normalized production data for each respective cluster of wells;
f) identifying a minimum number of the components and the corresponding weights in each production data matrix needed to reproduce the normalized production data for each respective cluster of wells;
g) calculating a fitted decline curve for the normalized production data for each respective cluster of wells using a first component in the minimum number of components identified for each respective cluster of wells and a standard decline curve; and
h) forecasting production data for one of one or more new and existing wells in each respective cluster of wells using the fitted decline curve for each respective cluster of wells.

11. The program carrier device of claim 10, wherein the number selected for clustering the well(s) of interest is one.

12. The program carrier device of claim 10, wherein the production data is forecast for the one or more existing wells using a product of the fitted decline curve for each respective cluster of wells, the weight corresponding to the first component for each respective cluster of wells, and a predetermined normalizing factor for each well in each respective cluster of wells.

13. The program carrier device of claim 10, wherein the production data is forecast for the one or more new wells using a product of the fitted decline curve for each respective cluster of wells and correlated completion parameters for each well in each respective cluster of wells.

14. The program carrier device of claim 13, wherein the completion parameters for each well in each respective cluster of wells are correlated with a predetermined normalizing factor for each well in each respective cluster of wells using the corresponding weights for each well in each respective cluster of wells.

15. The program carrier device of claim 13, wherein the completion parameters for each well in each respective cluster of wells are predetermined and comprise a number of fractures, permeability and a production value.

16. The program carrier device of claim 10, further comprising removing outliers from the one or more wells of interest before calculating the fitted decline curve for each respective cluster of wells.

17. The program carrier device of claim 10, further comprising repeating steps c)-f) for an increased number for clustering the one or more wells of interest until a predetermined acceptable variance is achieved between each first component in the minimum number of components identified for each respective cluster of wells and each first component in the minimum number of components identified for each respective increased cluster of wells.

18. The program carrier device of claim 10, wherein the minimum number of the components and the corresponding weights in each production data matrix are identified by comparing a distribution of Eigen values for a matrix representing the normalized production data for each well in each respective cluster of wells.

19. A program carrier device for carrying computer executable instructions for forecasting production data based on normalized production data for one or more wells of interest, the instructions being executable to implement:
a) identifying components and corresponding weights in a production data matrix using singular value decomposition and the normalized production data;
b) identifying a minimum number of the components and the corresponding weights in the production data matrix needed to reproduce the normalized production data;
c) selecting a number for clustering the well(s) of interest based on a distribution of the well(s) of interest according to the minimum number of the components identified in the production data matrix;
d) clustering the well(s) of interest based on the number selected for clustering and the well(s) of interest that have a similar production profile;
e) identifying components and corresponding weights in a production data matrix for each respective cluster of wells using singular value decomposition and the normalized production data for each respective cluster of wells;
f) identifying a minimum number of the components and the corresponding weights in each production data matrix needed to reproduce the normalized production data for each respective cluster of wells;
g) repeating steps c)-f) for an increased number for clustering the one or more wells of interest;
h) calculating a fitted decline curve for the normalized production data for each respective cluster of wells using a first component in the minimum number of components identified for each respective cluster of wells; and
i) forecasting production data for one of one or more new and existing wells in each respective cluster of wells using the fitted decline curve for each respective cluster of wells.

20. The method of claim 19, wherein the minimum number of the components and the corresponding weights in each production data matrix are identified by comparing a distribution of Eigen values for a matrix representing the normalized production data for each well in each respective cluster of wells.
